(19) United States
(12) Patent Application Publication
(10) Pub. No.: US 2026/0351889 A1
(43) Pub. Date: Nov. 5, 2026

(54) ELECTRIC CONNECTOR

(71) Applicant: BIZLINK INTERNATIONAL CORP., New Taipei City (TW)

(72) Inventors: Juan HU, New Taipei City (TW); Qixing XU, New Taipei City (TW); Haoran ZOU, New Taipei City (TW)

(21) Appl. No.: 19/661,706

(22) Filed: Apr. 29, 2026

(30) Foreign Application Priority Data
Apr. 30, 2025 (CN) 202510575573.5
Apr. 30, 2025 (CN) 202520876715.7

(51) Int. Cl. H01R 13/447; H01R 13/424; H01R 13/502; H01R 13/627; H01R 24/28; H01R 24/38; H01R 107/00

(52) U.S. Cl. CPC H01R 13/447; H01R 13/424; H01R 13/5025; H01R 13/6273; H01R 24/28; H01R 24/38; H01R 2107/00

(57) ABSTRACT

An electric connector includes a housing and a plurality of terminal modules. The housing includes a base and a plurality of protruding portions disposed on the base. The housing defines a plurality of through holes. One of the through holes extends through one of the protruding portions and the base. The terminal modules are respectively disposed in the through holes. Each of the terminal modules includes a conductive tubular member, an insulating member, and a conductive terminal. The conductive tubular member defines a cavity extending between opposite ends thereof. The insulating member is disposed in the cavity and configured to partition the cavity into a first cavity portion and a second cavity portion. The conductive terminal is disposed in the first cavity portion.

### CROSS-REFERENCE TO RELATED APPLICATION

This application claims priority to China Application Serial Number 202510575573.5, filed Apr. 30, 2025, and China Application Serial Number 202520876715.7, filed Apr. 30, 2025, the disclosures of which are incorporated herein by reference in their entireties.

### BACKGROUND

### Field of Invention

The present disclosure relates to an electric connector.

### Description of Related Art

Electric connectors are commonly used at power output ends and serve as interface components for transmitting electrical energy from a power module (for example, an uninterruptible power supply system, a battery pack, or a power distribution cabinet) to downstream equipment, and are commonly used to distribute main power to various power-consuming devices.

Existing electric connectors comprise a male connector or a female connector, and usually have metal terminals wrapped in an insulating housing. Since the electric connectors need to be coupled with other electric connectors, the insulating housing usually has an opening. During an insertion process, a server engineer may accidentally touch the metal terminals, resulting in a risk of electric shock. Such risk is particularly higher in server power supply applications involving high current and high voltage.

Therefore, how to propose an electric connector that can solve the aforementioned problems is one of the problems that the industry is currently eager to invest in research and development resources to solve.

### SUMMARY

In order to achieve the above objective, according to an embodiment of the present disclosure, an electric connector includes a housing and a plurality of terminal modules. The housing includes a base and a plurality of protruding portions disposed on the base. The housing defines a plurality of through holes. One of the through holes extends through one of the protruding portions and the base. The terminal modules are respectively disposed in the through holes. Each of the terminal modules includes a conductive tubular member, an insulating member, and a conductive terminal. The conductive tubular member defines a cavity extending between opposite ends thereof. The insulating member is disposed in the cavity and configured to partition the cavity into a first cavity portion and a second cavity portion. The conductive terminal is disposed in the first cavity portion.

In order to achieve the above objective, according to an embodiment of the present disclosure, an electric connector includes a housing, a plurality of conductive tubular members, a plurality of circular insulating crowns, and a hook. A surface of the housing defines a plurality of through holes extending therethrough. Each of the conductive tubular members is embedded in one of the through holes, and an axial center of each of the conductive tubular members defines an axial through hole extending therethrough. One of the circular insulating crowns is disposed at an end of one of the conductive tubular members. A hook is disposed on a side surface of the housing.

### BRIEF DESCRIPTION OF THE DRAWINGS

The invention can be more fully understood by reading the following detailed description of the embodiment, with reference made to the accompanying drawings as follows:
FIG. 1 is a perspective view of a male connector in accordance with an embodiment of the present disclosure;
FIG. 2 is a side view of the male connector in accordance with an embodiment of the present disclosure;
FIG. 3 is a perspective view of the male connector based on a section A-A’ of FIG. 2 in accordance with an embodiment of the present disclosure;
FIG. 4 is a partial enlarged view of the male connector based on a first position P1 of FIG. 3 in accordance with an embodiment of the present disclosure;
FIG. 5 is a partial enlarged view of the male connector based on a second position P2 of FIG. 3 in accordance with an embodiment of the present disclosure;
FIG. 6 is a perspective view of a female connector in accordance with an embodiment of the present disclosure;
FIG. 7 is a sided view of the female connector in accordance with an embodiment of the present disclosure;
FIG. 8 is a cross-sectional view of the female connector based on a section B-B’ of FIG. 7 in accordance with an embodiment of the present disclosure;
FIG. 9 is a perspective view of a male connector in accordance with another embodiment of the present disclosure;
FIG. 10 is a cross-sectional view of the male connector based on a section C-C’ of FIG. 9 in accordance with another embodiment of the present disclosure;
FIG. 11 is a perspective view of a female connector in accordance with another embodiment of the present disclosure;
FIGS. 12A and 12B are perspective views of a female connector in accordance with yet another embodiment of the present disclosure; and
FIGS. 13A and 13B are perspective views of a female connector in accordance with still another embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit the present disclosure. In other words, in some embodiments of the present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

The present disclosure provides electric connectors, which aim to prevent fingers from suffering an electric shock.

Reference is made to FIGS. 1-5 . In an embodiment of the present disclosure, the male connector 100 includes a housing 1 and a plurality of terminal modules 2. The housing 1 includes a base 11 and a plurality of protruding portions 12. The protruding portions 12 are separated from each other on a surface of the base 11. The housing 1 defines a plurality of through holes, and one of the through holes extends through one of the protruding portions 12 and the base 11. Each of the terminal modules 2 includes a conductive tubular member 21, an insulating member 22, a conductive terminal 23, and an insulating part 24. One of the conductive tubular members 21 is disposed in one of the through holes. The insulating part 24 is disposed on an end surface of the conductive tubular member 21 away from the base 11. The conductive tubular member 21 defines a cavity extending between opposite ends thereof. An end of the insulating member 22 is connected to a cavity wall of the cavity and partitions the cavity into a first cavity portion and a second cavity portion. The other end of the insulating member 22 extends from the cavity wall toward an opening of the first cavity portion. The conductive terminal 23 is disposed in the first cavity portion.

In this embodiment, the male connector 100 is used at a cable end. The housing 1 is made of an insulating material, such as rigid plastic or rigid rubber, so as to prevent current from leaking outward through the housing 1 and causing problems such as a short circuit. The housing 1 includes the base 11 and the protruding portions 12. The base 11 and the protruding portions 12 may be integrally formed by an injection molding process, or may be connected as one body by bonding, ultrasonic welding, or the like, which is not further limited herein. The conductive tubular member 21 has a tubular structure and has a through cavity therein. Specifically, the conductive tubular member 21 may be made of copper, aluminum, or the like. The conductive tubular member 21 is disposed in the through hole, and the connection between the conductive tubular member 21 and the hole wall of the through hole may be a snap-fit connection or an insertion connection. The insulating member 22 is inserted through the cavity of the conductive tubular member 21 and is connected to the cavity wall of the cavity. Further, an end of the insulating member 22 is detachably connected to the cavity wall of the cavity, and the specific connection may be, for example, a threaded connection or an insertion connection. The insulating member 22 is made of an insulating material such as silica gel or rubber, so as to prevent electric shock caused by accidental finger contact. An end of the insulating member 22 is connected to the cavity wall of the cavity, so that the cavity in the conductive tubular member 21 is partitioned into the first cavity portion and the second cavity portion. The other end of the insulating member 22 extends from the cavity wall toward the opening of the first cavity portion. The opening of the first cavity portion is used for insertion of another electric connector. The conductive terminal 23 is disposed on the cavity wall of the first cavity portion. The second cavity portion is used for welding an electric connection wire, so as to realize current input or output. An opening at a side of the through hole is used for inserting into another electric connector. The end surface of the conductive tubular member 21 facing the opening is provided with the insulating part 24. The insulating part 24 is an annular structure made of an insulating material, such as a silica gel ring or a rubber ring, so as to prevent electric shock caused by accidental contact with the end surface of the conductive tubular member 21.

Specifically, the conductive terminal 23 includes two metal rings and a plurality of arc-shaped metal strips connected between the two metal rings. It can be understood that the metal strips are all bent toward a central axis direction of the first cavity portion so as to clamp another connecting terminal inserted into the conductive tubular member 21 and realize current conduction. The conductive terminal 23 may be connected to the cavity wall of the first cavity portion by a snap-fit connection or welding, or alternatively, two step surfaces may be disposed on the cavity wall at intervals, so that two ends of the conductive terminal 23 are clamped between the two step surfaces, thereby limiting a relative position between the conductive terminal 23 and the conductive tubular member 21.

The male connector 100 of the present disclosure includes the housing 1 and the terminal modules 2. The housing 1 includes the base 11 and the protruding portions 12. The through holes extend through the housing 1. One terminal module 2 is disposed in each of the through holes. Each of the terminal modules 2 includes the conductive tubular member 21, the insulating member 22, the conductive terminal 23, and the insulating part 24. The insulating member 22 is connected to an inner wall of the conductive tubular member 21. The insulating part 24 is disposed on the end surface of the conductive tubular member 21. The conductive terminal 23 is disposed on the cavity wall of the first cavity portion. Current is mainly conducted through the conductive tubular member 21 and the conductive terminal 23. The insulating part 24 disposed on the end surface of the conductive tubular member 21 and the insulating member 22 in the middle can prevent fingers from being mistakenly inserted and thereby causing electric shock.

In some embodiments, a distal end of the other end of the insulating member 22 extends beyond and is exposed relative to the conductive terminal 23, and does not protrude beyond the corresponding protruding portion 12.

In this embodiment, in order to prevent a finger from being inserted into a gap between the insulating member 22 and the conductive terminal 23 and causing electric shock, the length of the insulating member 22 should extend beyond the position of the conductive terminal 23, but does not expose beyond the corresponding protruding portion 12. In a preferred embodiment, the end surface of the insulating member 22 facing the opening is flush with the end surface of the conductive tubular member 21. When a finger accidentally touches the structure, the finger first contacts the end surface of the insulating member 22 or the insulating part 24 on the end surface of the conductive tubular member 21, and will not directly touch a conductive material portion, thereby reducing a risk of electric shock.

In some embodiments, one of the insulating part 24 and the conductive tubular member 21 has a barb 211, the other one of the insulating part 24 and the conductive tubular member 21 has an engaging groove 241, and the barb 211 is engaged with the engaging groove 241 so as to connect the insulating part 24 and the conductive tubular member 21.

In this embodiment, the insulating part 24 is made of an insulating material such as silica gel or rubber, and the conductive tubular member 21 is made of a metal material such as copper or aluminum. The connection between the two may be realized by forming a barb 211 on one of them and an engaging groove 241 on the other one, such that the barb 211 is engaged in the engaging groove 241, thereby connecting the insulating part 24 to the end surface of the conductive tubular member 21. It can be understood that, in other embodiments, the insulating part 24 and the conductive tubular member 21 may also be connected by adhesive bonding or an interference-fit snap connection, so as to connect the insulating part 24 to the end surface of the conductive tubular member 21.

In some embodiments, the housing 1 further includes two convex plates 13. The two convex plates 13 are respectively disposed on opposite sides of a surface of the base 11 in a length direction thereof. The two convex plates 13 and outer walls of the protruding portions 12 cooperatively define an embedded groove.

A ratio of a height of each of the convex plates 13 to a height of each of the protruding portions 12 is greater than or equal to 10% and less than or equal to 70%.

In this embodiment, the convex plate 13 is disposed on each of two opposite sides, in the length direction (e.g., direction X), of the surface of the base 11 on which the protruding portions 12 are disposed. The two convex plates 13 and the protruding portions 12 located therebetween cooperatively define an embedded groove. Two ends of the embedded groove in the length direction are open. The embedded groove is used to accommodate an inserting portion of an external electric connector, so that insertion connection between the two electric connectors is more stable.

The ratio of the height of each of the convex plates 13 to the height of each of the protruding portions 12 is greater than or equal to 10% and less than or equal to 50% or 70%, for example, 10%, 20%, 30%, 40%, 50%, 70%, or any value within the above range. The ratio of the height of each of the convex plates 13 to the height of each of the protruding portions 12 should not be too small, because this would cause the insertion connection between the two electric connectors to be unstable, and even result in electric connection failure and a power interruption problem of an electric device. The ratio of the height of each of the convex plates 13 to the height of each of the protruding portions 12 should also not be too large. If too large, it will lead to waste of material, and the depth of the embedded groove will be too deep, which will cause the insertion connection between the two electric connectors to be too tight and not easy to insert or remove.

In some embodiments, a gap 212 is formed between the conductive tubular member 21 and the hole wall of the through hole.

The conductive tubular member 21 includes a first mesa 213 on the outer wall of the conductive tubular member 21, and the housing 1 includes a second mesa 14 on the hole wall of the through hole, in which the first mesa 213 abuts against the second mesa 14.

The outer wall of the conductive tubular member 21 defines a recessed groove 214. The recessed groove 214 is located on a side of the second mesa 14 away from the first mesa 213. A blocking part 215 is disposed in the recessed groove 214. The hole wall of the through hole abuts against the blocking part 215 and a groove bottom of the recessed groove 214.

In this embodiment, a specific connection manner between the conductive tubular member 21 and the hole wall of the through hole is as follows. The conductive tubular member 21 includes the first mesa 213 on the outer wall of the conductive tubular member 21, and the hole wall of the through hole includes the second mesa 14, in which the first mesa 213 abuts against the second mesa 14. The outer wall of the conductive tubular member 21 defines the recessed groove 214. The recessed groove 214 is located on the side of the second mesa 14 away from the first mesa 213. The blocking part 215 is disposed in the recessed groove 214, and the hole wall of the through hole abuts against the blocking part 215 and the groove bottom of the recessed groove 214. The first mesa 213 and the blocking part 215 in the recessed groove 214 are disposed on opposite sides of the second mesa 14. The first mesa 213 and the blocking part 215 work together to limit a relative position between the conductive tubular member 21 and the hole wall of the through hole in an axial direction (e.g., direction Z). The blocking part 215 may be an O-ring or a C-shaped rubber strip, so as to increase friction between the conductive tubular member 21 and the hole wall of the through hole and prevent relative displacement therebetween.

In some embodiments, the insulating member 22 is threadedly connected to the cavity wall of the cavity of the conductive tubular member 21.

In this embodiment, an outer surface of the insulating member 22 is formed with an external thread, and the cavity wall of the cavity of the conductive tubular member 21 is formed with an internal thread. By a tightening action between the internal thread and the external thread, the insulating member 22 is threadedly connected to the cavity wall of the cavity of the conductive tubular member 21, so as to fix the insulating member 22 on the cavity wall of the cavity without an additional adhesive or latch structure, thereby simplifying the assembly process. At the same time, this ensures that the relative position between the insulating member 22 and the metal terminal is fixed, thereby preventing the insulating member 22 from shifting and causing a gap on aside to become excessively large, so that a finger can be inserted to touch the conductive terminal 23 and suffer an electric shock. The threaded connection provides a more durable fixing effect through mechanical engagement, and can still maintain a stable connection even in a high-temperature or vibrating environment. Further, the threaded connection facilitates disassembly, assembly, and maintenance, thereby reducing the overall replacement cost caused by damage to the fixing structure.

In some embodiments, the male connector 100 further includes a latch 3. A U-shaped blocking plate 111 is disposed on a side wall of the base 11. The latch 3 is rotatably connected to two side plates of the U-shaped blocking plate 111 through a rotating shaft. An end portion of the latch 3 is partially exposed on a surface of the base 11.

In this embodiment, the male connector 100 is provided with the U-shaped blocking plate 111 on a side wall of the base 11, and is further provided with the latch 3 rotatably connected to the two side plates of the U-shaped blocking plate 111. An end portion of the latch 3 is partially exposed on the surface of the base 11 on which the protruding portions 12 are disposed, and is used to be buckled and connected with another electric connector, so as to improve connection strength between the two connectors and prevent misoperation from pulling the two apart and causing electrical connection failure. The rotational movement of the latch 3 relative to the U-shaped blocking plate 111 is realized by a shaft-hole fitting connection between the latch 3 and the two side plates of the U-shaped blocking plate 111, so as to realize the effects of buckled connection with and release from the another electric connector.

In some embodiments, an elastic part 31 is connected between the other end of the latch 3 and a side wall of the housing 1. The elastic part 31 is used to push the other end of the latch 3 away from the side wall of the housing 1.

In some embodiments, a quantity of the latch 3 and a quantity of the U-shaped blocking plate 111 are each two, and one latch 3 and one U-shaped blocking plate 111 are disposed on one side wall of the base 11.

In this embodiment, the latch 3 is integrally formed from a metal material by blanking or stamping. The latch 3 sequentially includes, from a head portion to an end portion, a pressing portion, a necking portion, a connecting portion, a bending portion, and a connecting frame. The pressing portion is in a cylindrical hollow shape, and a space is provided inside the pressing portion to accommodate the elastic part 31 such as a spring. An end of the elastic part 31 is embedded in the hollow pressing portion, and the other end is embedded in a shallow groove in the side wall of the base 11. Left and right sides of the connecting portion are respectively connected to a left arm and a right arm bent vertically toward the base 11. Apertures on the left arm and the right arm are penetrated by the rotating shaft so as to be rotatably connected to the two side plates of the U-shaped blocking plate 111. The bending portion includes two right-angle bends. The connecting frame includes a rectangular aperture for insertion and fixation of a hook of the another electric connector. The connecting frames of the two latches 3 respectively block the two open ends of the embedded groove in the length direction and do not protrude beyond the convex plates 13. An end of the latch 3 is used to be buckled and connected with the another electric connector, and an elastic part 31 is disposed between the other end of the latch 3 and a side wall of the housing 1. In an initial state, the two ends of the latch 3 are located on the same horizontal plane. When the other end of the latch 3 is pressed, the elastic part 31 is compressed, and an end of the latch 3 rises away from the side wall of the base 11. At this time, the male connector 100 is in an unlocked state, and another electric connector may be inserted into the male connector 100. After the pressing force is released, the elastic part 31 recovers from deformation and pushes the other end of the latch 3 toward a direction away from the side wall of the housing 1, so that an end of the latch 3 descends toward the side wall of the base 11 and is buckled and connected with the another electric connector, thereby improving connection stability therebetween.

In one embodiment, in order to further improve connection stability between the two electric connectors, one U-shaped blocking plate 111 and one latch 3 are respectively disposed on two side walls of the base 11, so that connection on both sides of the base 11 is synchronized and stable, thereby preventing electrical connection failure caused by one-sided inclination.

In some embodiments, the quantity of the protruding portions 12 is greater than or equal to four.

In some embodiments, an overall thickness of the male connector 100 is greater than or equal to 22 mm and less than or equal to 40 mm.

In some embodiments, the outer wall of each of the protruding portions 12 is provided with a guiding groove 15 or a guiding protrusion 121, and the guiding groove 15 or the guiding protrusion 121 extends along an axial direction (e.g., direction Z) of the protruding portion 12.

In some embodiments, a radial protruding direction (e.g., direction Y) of the guiding groove 15 or the guiding protrusion 121 is perpendicular to an arranging direction (e.g., direction X) of the protruding portions.

In this embodiment, the quantity of the protruding portions 12 is greater than or equal to four, for example, four, five, seven, or more. The quantity of the protruding portions 12 may be the same as the quantity of the terminal modules 2. The terminal modules 2 can carry a larger current, thereby realizing large-current transmission between the two electric connectors. Diameters of the protruding portions 12 are the same. However, when needed, auxiliary protruding portions having a smaller diameter and a lower height for transmitting signals may additionally be provided.

In one embodiment, the overall thickness of the male connector 100 is greater than or equal to 22 mm and less than or equal to 40 mm, for example, 22 mm, 26 mm, 30 mm, 40 mm, or any value within the above range. The overall thickness of the male connector 100 should not be too small. If too small, the thickness of the internal terminal modules 2 will be decreased, such that a relatively large current cannot be carried. The overall thickness of the male connector 100 should also not be too large. If too large, the male connector 100 will not be adapted to a server.

In one embodiment, in order to assist insertion connection between the male connector 100 and another electric connector, the male connector 100 is provided with the guiding groove 15 or the guiding protrusion 121 on the outer wall of the protruding portion 12, thereby achieving effects of guiding an insertion direction, limiting the insertion direction, and marking front and rear orientations.

Reference is made to FIGS. 6-8. The present disclosure further provides a female connector 200 used at a board end. The female connector 200 includes a housing 1, a plurality of conductive tubular members 21, a plurality of circular insulating crowns 4, and a hook 5. A surface of the housing 1 defines a plurality of through holes extending therethrough. Each of the conductive tubular members 21 is embedded in one of the through holes, and an axial center of each of the conductive tubular members 21 defines an axial through hole extending therethrough. A circular insulating crown 4 is disposed at an end of one of the conductive tubular members 21. The hook 5 is disposed on a side surface of the housing 1.

In this embodiment, the housing 1 is made of an insulating material, such as rigid plastic or rigid rubber, so as to prevent current from leaking outward through the housing 1 and causing problems such as a short circuit. The housing 1 defines a plurality of through holes therein. Each of the conductive tubular members 21 has a tubular structure and also has a through hole extending therethrough therein. Specifically, the conductive tubular member 21 may be made of copper, aluminum, or the like. The conductive tubular member 21 is inserted through and disposed in the through hole, and the connection between the conductive tubular member 21 and the hole wall of the through hole may be a snap-fit connection or an insertion connection. A circular insulating crown 4 is disposed at an end of the conductive tubular member 21. The circular insulating crown 4 is an annular structure made of an insulating material, such as a silica gel ring or a rubber ring, so as to prevent electric shock caused by accidental contact with the end surface of the conductive tubular member 21. The connection between the circular insulating crown 4 and the conductive tubular member 21 may be realized by forming a barb 211 on one of them and an engaging groove 241 on the other one, such that the barb 211 is engaged in the engaging groove 241, thereby connecting the circular insulating crown 4 to the end surface of the conductive tubular member 21. It can be understood that, in other embodiments, the circular insulating crown 4 and the conductive tubular member 21 may also be connected by adhesive bonding or an interference-fit snap connection, so as to connect the circular insulating crown 4 to the end surface of the conductive tubular member 21.

A through hole is also defined in the conductive tubular member 21, and the hook 5 is disposed on a side of the housing 1. When the male connector 100 at the cable end is inserted into and connected to the female connector 200 at the board end, the insulating member 22 is inserted into the through hole of the conductive tubular member 21 of the female connector 200 at the board end, and the conductive terminal 23 of the male connector 100 at the cable end abuts against the outer wall of the conductive tubular member 21 of the female connector 200 at the board end, so as to realize current conduction. Further, the latch 3 of the male connector 100 at the cable end is buckled and connected with the hook 5 of the female connector 200 at the board end, thereby improving connection strength therebetween.

Reference is made to FIGS. 9 and 10. In another embodiment of the present disclosure, a male connector 100’ is provided. The structural configuration of the male connector 100’ is similar to the structural configuration of the male connector 100, the difference therebetween is that the male connector 100’ includes a housing 1’ and a terminal module 2’ instead of the housing 1 and the terminal module 2. The housing 1’ includes a protruding portion 12’ different from the protruding portion 12. Specifically, a height of the protruding portion 12’ is greater than that of the protruding portion 12, such that a conductive tubular member 21’ and an insulating member 22’ of the terminal module 2’ are fully located within the protruding portion 12’. A radial protruding direction of a guiding protrusion 121’ of the protruding portion 12’ forms an acute angle to an arranging direction (e.g., direction X) of the protruding portions 12’. For simplicity, the same features will not be further repeated or discussed herein.

Reference is made to FIG. 11. In another embodiment of the present disclosure, a female connector 200’ is provided. The structural configuration of the female connector 200’ is similar to the structural configuration of the female connector 200, the difference therebetween is that the female connector 200’ includes a housing 1’, a conductive tubular member 21’, and a circular insulating crown 4’ instead of the housing 1, the conductive tubular member 21, and the circular insulating crown 4. Specifically, a height of the housing 1’ is greater than that of the housing 1, such that the conductive tubular member 21’ and the circular insulating crown 4’ are fully located within the through hole of the housing 1’. A diameter in a radial direction of the circular insulating crown 4’ tapers along an axial direction (e.g., negative direction Z) of the through hole of the housing 1’. A radial protruding direction of a guiding groove 15’ on the hole wall of the through hole of the housing 1’ forms an acute angle to an arranging direction (e.g., direction X) of the conductive tubular members 21’ or the through holes of the housing 1’. For simplicity, the same features will not be further repeated or discussed herein.

Reference is made to FIGS. 12A and 12B. In yet another embodiment of the present disclosure, a female connector 200’ is provided. The structural configuration of the female connector 200’ of FIGS. 12A and 12B is similar to the structural configuration of the female connector 200’ of FIG. 11, the difference therebetween is that the female connector 200’ of FIGS. 12A and 12B further includes a cover body 7 connected to one of two opposite side surfaces of the housing 1’ and covering the through holes of the housing 1’. The cover body 7 includes a plurality of plugs 71 configured to be individually engaged with the through holes of the housing 1’ and a convex bar 72 protruding away from the plugs 71. For simplicity, the same features will not be further repeated or discussed herein.

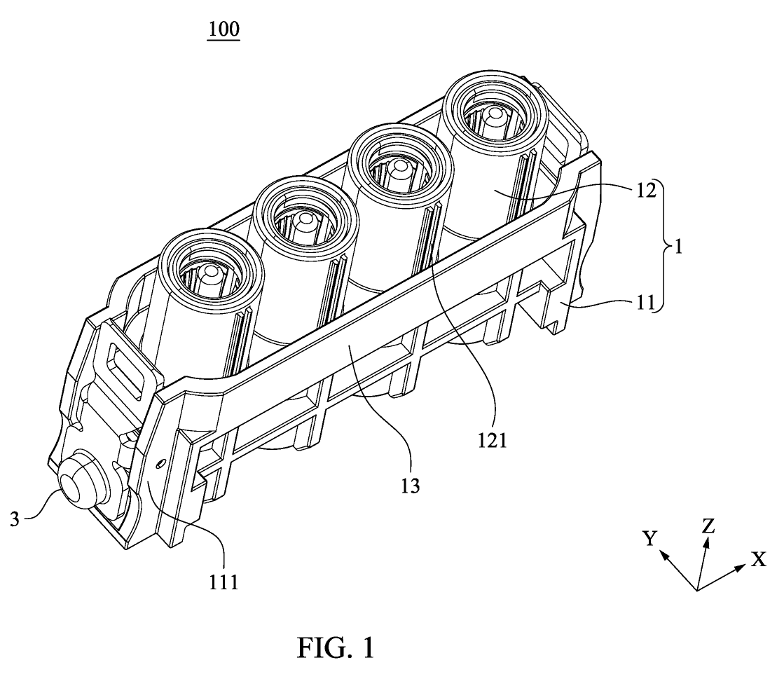

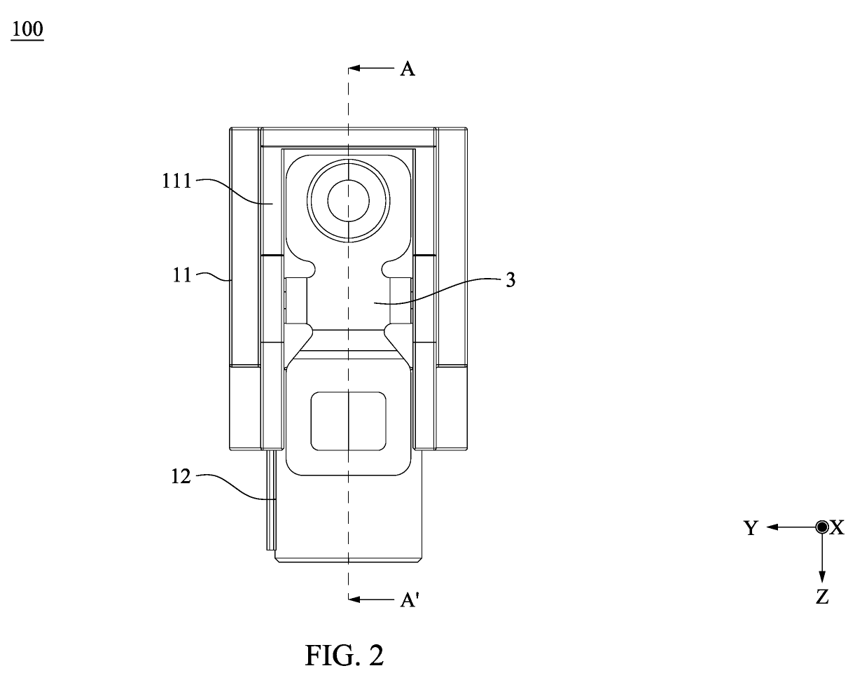

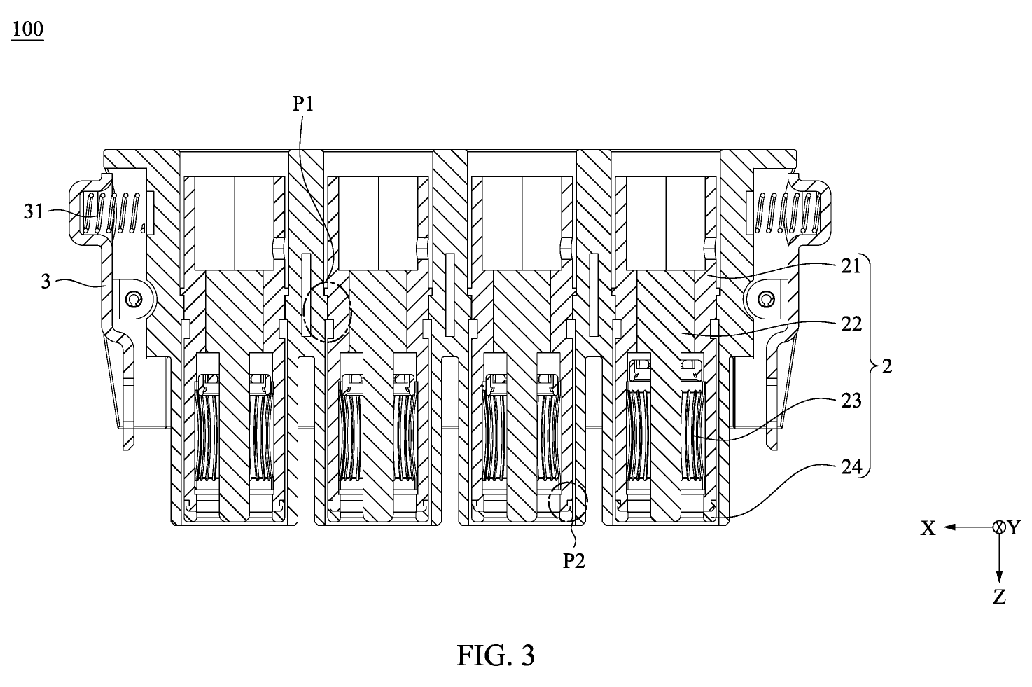

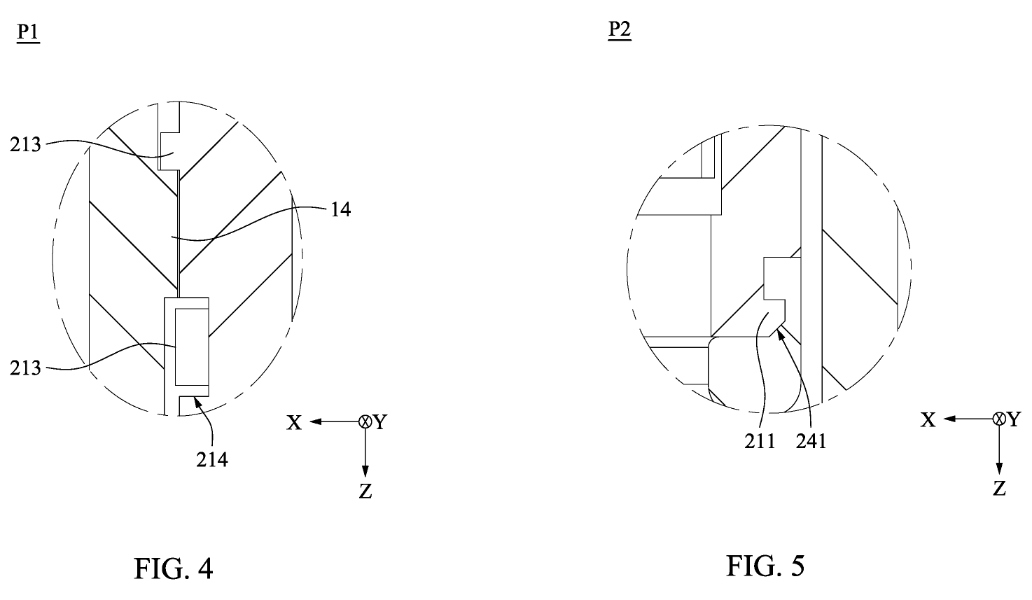

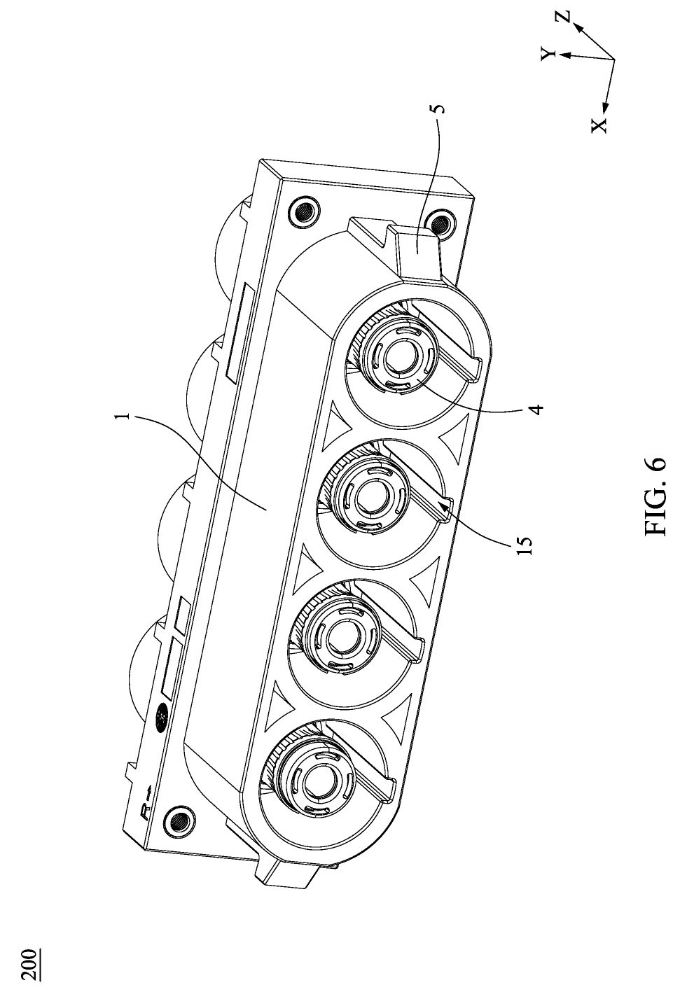

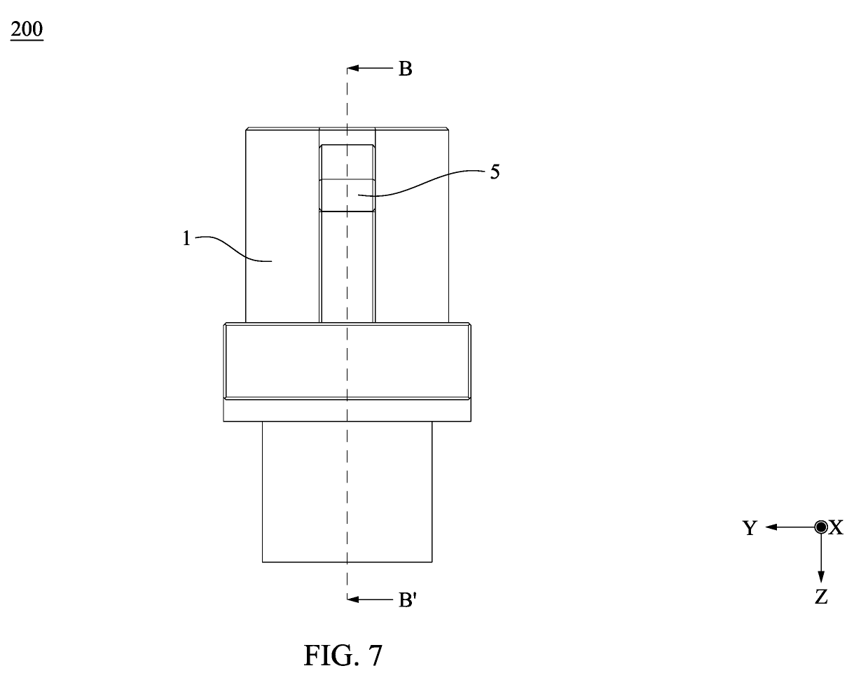

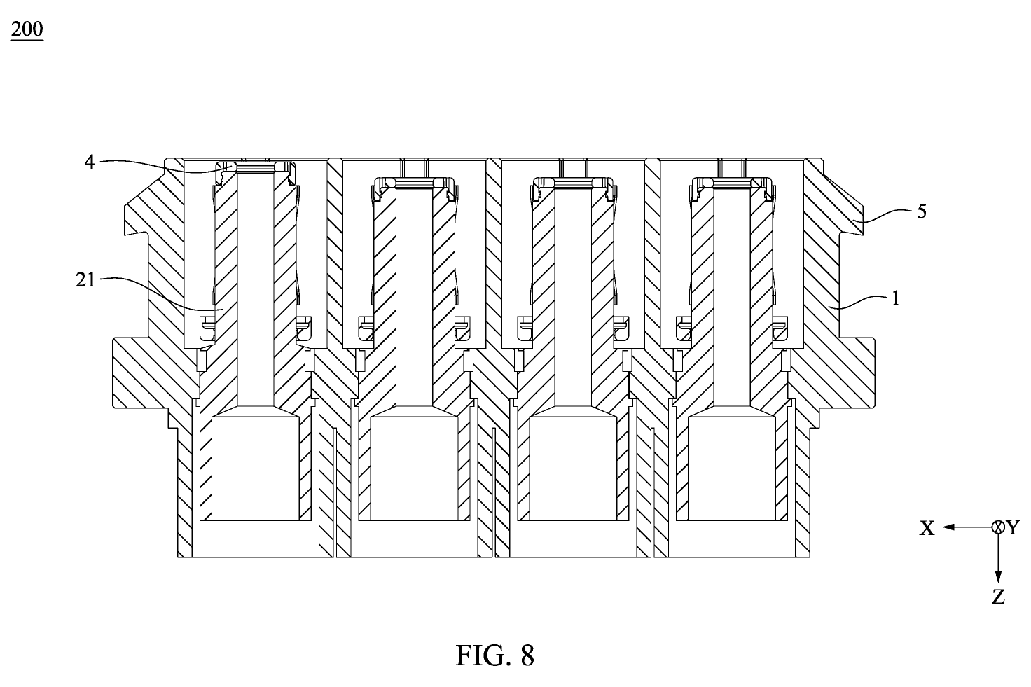

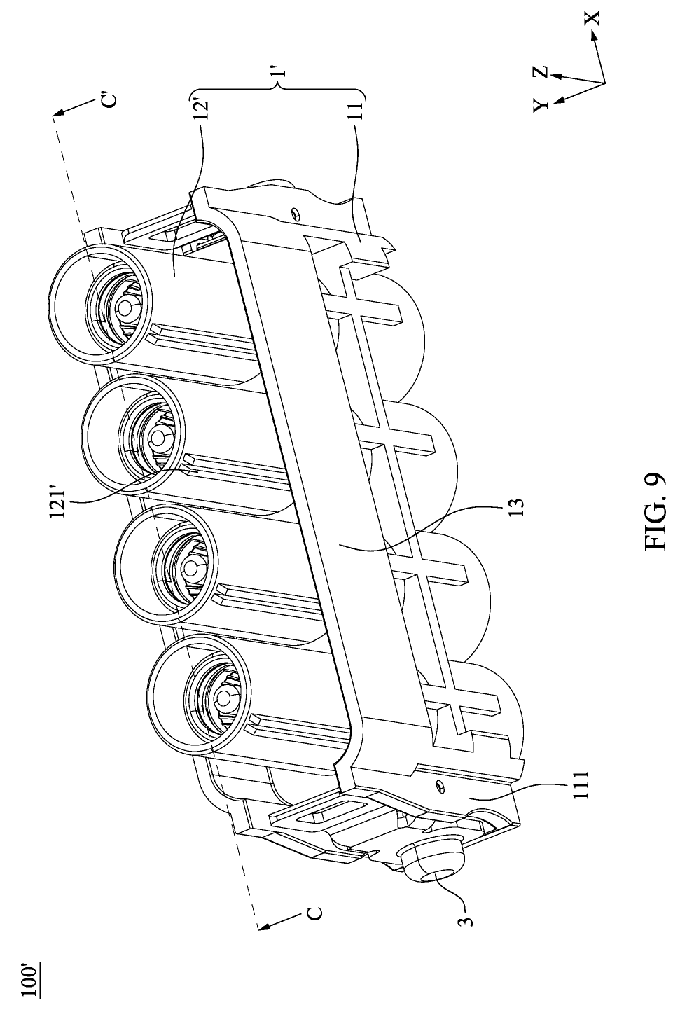

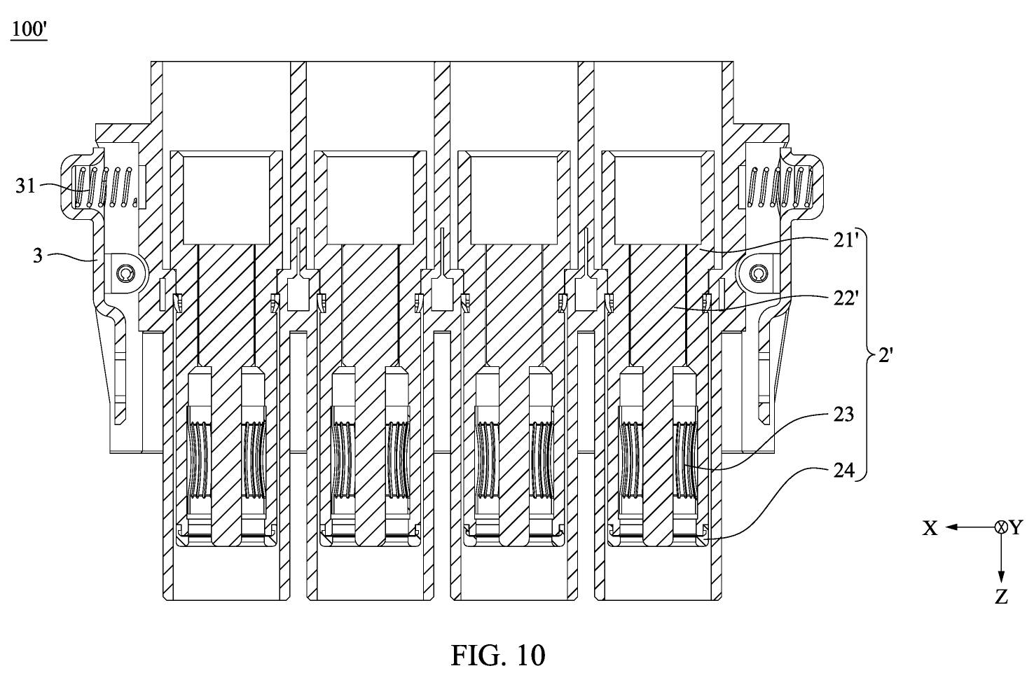

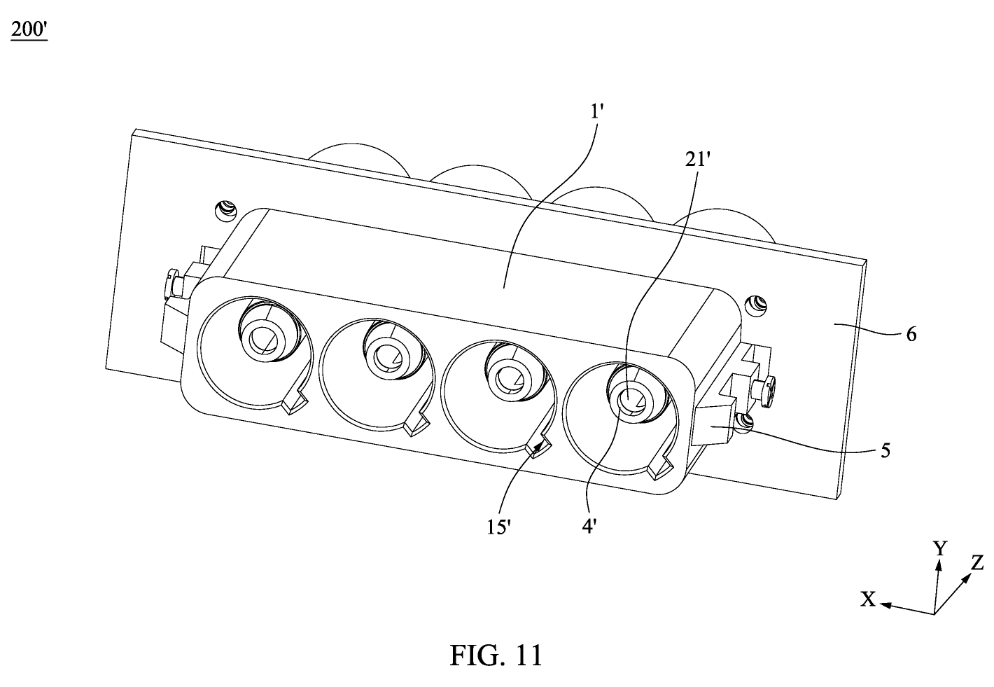

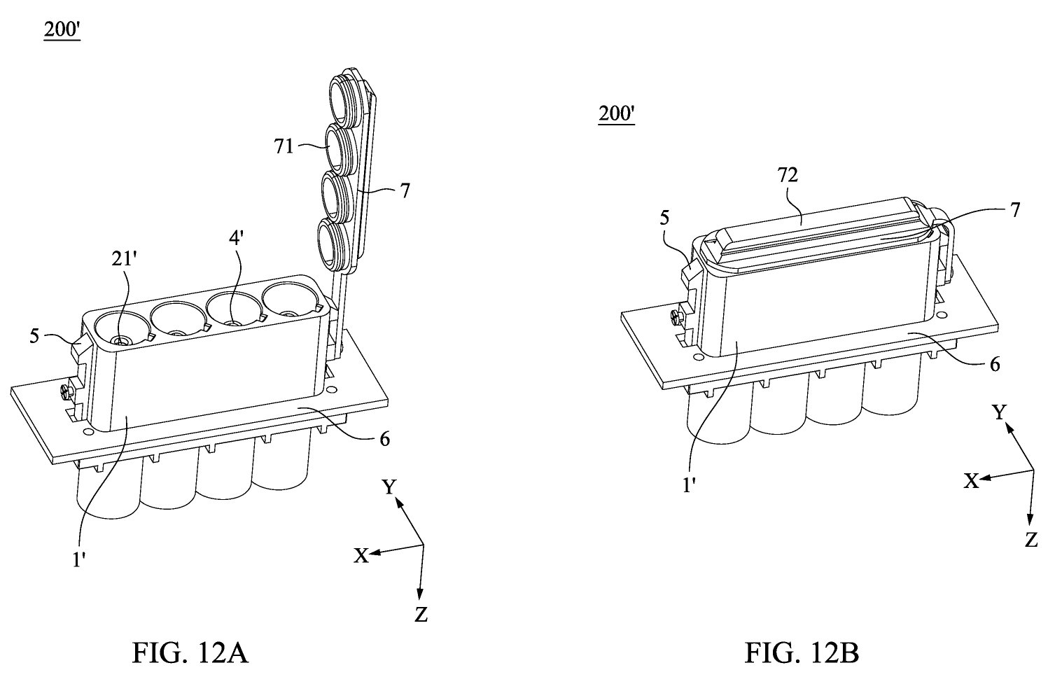

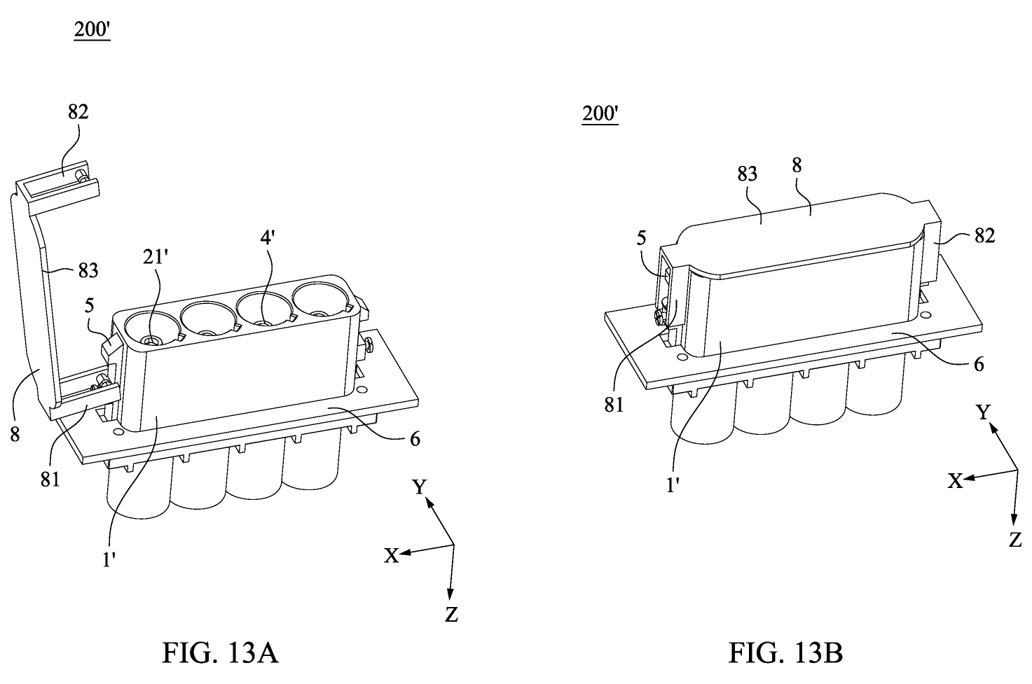

Reference is made to and FIGS. 13A and 13B. In still another embodiment of the present disclosure, a female connector 200’ is provided. The structural configuration of the female connector 200’ of FIGS. 13A and 13B is similar to the structural configuration of the female connector 200’ of FIGS. 12A and 12B and , the difference therebetween is that the female connector 200’ of FIGS. 13A and 13B includes a cover body 8 instead of the cover body 7. The cover body 8 is pivotally connected to one of two opposite side surfaces of the housing 1’ and covers the through holes of the housing 1’. The cover body 8 includes a pivoting portion 81 pivotally connected to the one of the two opposite side surfaces of the housing 1’, a free portion 82 configured to be engaged with the other one of the two opposite side surfaces of the housing 1’, and a cover main body 83 configured to cover the through holes of the housing 1’. The pivoting portion 81 and the free portion 82 are respectively connected to two opposite sides of the cover main body 83. For simplicity, the same features will not be further repeated or discussed herein.

Although the present disclosure has been described with reference to the above embodiments, it is not intended to limit the present disclosure. Various modifications and refinements may be made by those skilled in the art without departing from the spirit and scope of the present disclosure. Therefore, the scope of protection of the present disclosure shall be defined by the appended claims.

What is claimed is:

1. An electric connector, comprising:
a housing comprising a base and a plurality of protruding portions disposed on the base, wherein the housing defines a plurality of through holes, and one of the through holes extends through one of the protruding portions and the base; and
a plurality of terminal modules respectively disposed in the through holes, wherein each of the terminal modules comprises:
a conductive tubular member defining a cavity extending between opposite ends thereof;
an insulating member disposed in the cavity and configured to partition the cavity into a first cavity portion and a second cavity portion; and
a conductive terminal disposed in the first cavity portion.

2. The electric connector of claim 1, wherein an end of the insulating member is connected to a cavity wall of the cavity, and the other end of the insulating member extends from the cavity wall toward an opening of the first cavity portion.

3. The electric connector of claim 2, wherein a distal end of the other end of the insulating member extends beyond and is exposed relative to the conductive terminal, and does not protrude beyond the corresponding protruding portion.

4. The electric connector of claim 1, wherein each of the terminal modules further comprises an insulating part disposed on an end surface of the conductive tubular member away from the base, one of the insulating part and the conductive tubular member comprises a barb, the other one of the insulating part and the conductive tubular member has an engaging groove, and the barb is engaged with the engaging groove so as to connect the insulating part and the conductive tubular member.

5. The electric connector of claim 1, wherein the housing further comprises two convex plates, the two convex plates are respectively disposed on opposite sides of a surface of the base in a length direction thereof, and the two convex plates and outer walls of the protruding portions cooperatively define an embedded groove, and wherein a height of each of the two convex plates is 10% to 70% of a height of each of the protruding portions.

6. The electric connector of claim 1, wherein a gap is formed between an outer wall of the conductive tubular member and a hole wall of one of the through holes.

7. The electric connector of claim 6, wherein the conductive tubular member comprises a first mesa on the outer wall of the conductive tubular member, and the housing comprises a second mesa on the hole wall of one of the through holes, and the first mesa abuts against the second mesa.

8. The electric connector of claim 7, wherein the outer wall of the conductive tubular member defines a recessed groove, the recessed groove is located on a side of the second mesa away from the first mesa, a blocking part is disposed in the recessed groove, and the hole wall of the through hole abuts against the blocking part and a groove bottom of the recessed groove.

9. The electric connector of claim 1, wherein the insulating member is threadedly connected to a cavity wall of the cavity of the conductive tubular member.

10. The electric connector of claim 1, further comprising a latch, wherein a U-shaped blocking plate is disposed on a side wall of the base, the latch is rotatably connected to two side plates of the U-shaped blocking plate through a rotating shaft, and an end portion of the latch is partially exposed on a surface of the base.

11. The electric connector of claim 10, wherein the other end of the latch is connected to a side wall of the housing through an elastic part, the elastic part is configured to push the other end of the latch away from the side wall of the housing.

12. The electric connector of claim 10, wherein a quantity of the latch and a quantity of the U-shaped blocking plate are each two, one of a plurality of the latches and one of a plurality of the U-shaped blocking plates are disposed on the side wall of the base.

13. The electric connector of claim 1, wherein a quantity of the protruding portions is greater than or equal to 4.

14. The electric connector of claim 1, wherein an overall thickness of the electric connector is greater than or equal to 22 mm and less than or equal to 40 mm.

15. The electric connector of claim 1, wherein each of the protruding portions comprises a guiding groove or a guiding protrusion disposed on an outer wall of the protruding portions, the guiding groove or the guiding protrusion extending along an axial direction of the protruding portions.

16. The electric connector of claim 15, wherein a radial protruding direction of the guiding groove or the guiding protrusion is perpendicular to an arranging direction of the protruding portions.

17. The electric connector of claim 15, wherein a radial protruding direction of the guiding groove or the guiding protrusion forms an acute angle to an arranging direction of the protruding portions.

18. An electric connector, comprising:
a housing, wherein a surface of the housing defines a plurality of through holes extending therethrough;
a plurality of conductive tubular members, wherein each of the conductive tubular members is embedded in one of the through holes, and an axial center of each of the conductive tubular members defines an axial through hole extending therethrough;
a plurality of circular insulating crowns, wherein one of the circular insulating crowns is disposed at an end of one of the conductive tubular members; and
a hook disposed on a side surface of the housing.

19. The electric connector of claim 18, further comprising a circular insulating crown disposed at an end of one of the conductive tubular members.

20. The electric connector of claim 18, further comprising a cover body pivotally connected to one of two opposite side surfaces of the housing.
